(19) United States
(12) Patent Application Publication
(10) Pub. No.: US 2011/0214151 A1
(43) Pub. Date: Sep. 1, 2011

(54) HANDHELD MOBILE TV SERVICE DEVICE

(76) Inventor: Yong Hun Kim, Gyeonggi-do (KR)

(21) Appl. No.: 12/741,626

(22) PCT Filed: Feb. 9, 2010
(86) PCT No.: PCT/KR10/00807

§ 371 Date: May 6, 2010

(51) Int. Cl. H04N 7/16

(52) U.S. Cl. 725/62

(57) ABSTRACT

A mobile TV service device is disclosed. A mobile TV service device includes a mobile TV signal receiver air-interfaced with a mobile TV network to receive a mobile TV signal, a device connection terminal connected with a signal input/output terminal of a handheld device, a mobile TV signal converter configured to convert the mobile TV signal into a motion picture having a format supportable by the handheld device, and a device connection controller configured to control electrical connection with the handheld device, when the handheld device is connected with the device connection terminal, and to transmit the motion picture converted from the mobile TV signal to the handheld device via the device connection terminal.

### BACKGROUND OF THE DISCLOSURE

1. Field of the Disclosure

The present invention relates to a handheld mobile TV service device, more particularly, to a handheld mobile TCV service device which can supply a mobile TV signal directly received from a mobile TV network to a handheld device capable of playing a motion picture of and not providing a mobile TV service such as DMB.

2. Discussion of the Related Art

A mobile TV called as ‘handheld TV’ is a service enabling a user to view broadcasting programs by way of a portable terminal, which can be supplied via a mobile TV network different from 3G network. Variety of technology-based mobile TV services are supplied via DVB-H supplied via auxiliary networks, for example, Nokia of Europe, MediaFLO of Qualcomm and Japanese 1seg and the like, with the start of Korean DMB service, to enable users to view broadcasting programs in motion by way of a portable terminal.

Recently, US standards of a mobile TV have been determined and ATSC (Advanced Television Standards Committee) has determined ATSC-M/H type as US mobile TV standards. As a result, MediaFLO of Qualcomm which is international standard of mobile TV and ATSC-M/H which is US national standard of mobile TV begins to compete.

ATSC-M/H is an extended version of ATSCA/53 which is a fixed terrestrial DTV as digital TV broadcasting standards transfer technology of Northern America continent. Since it is the extended version of conventional digital TV technology, it is the biggest advantage of ATSCA/53 that broadcasting transmission may be enabled without equipment change. If terrestrial DTV is transmitted, the terrestrial DTV is applied and a mobile TV signal can be transmitted. Because of that, broadcasting companies can use this technology without a bit expense.

Currently, the mobile TV market is in its early stages in the world. European type DVB-H is a subscription-based only to have difficulties in worldwide usage expansion. MediaFLO is also supplied partially only in the U.S and Asian countries are adopting MediaFLO, not decided yet. If the mobile TV market is activated, it seems that a mobile TV receiving chip a technology such as chips related to ATSC-M/H reception can be applied to mobile phones, A/V for vehicles and various kinds of mobile devices. However, the mobile TV market cannot be activated worldwide because of expense concern, lack of relating technology, lack of infrastructures and the like.

The reason why the mobile TV market is not activated fast as much as expected is lack of commodity. That is, since each of broadcasting companies in the countries provides a different mobile TV signal type of mobile TV service, there are variety of service types and according to one of examples a different receiving chip has to be mounted in each terminal used to view a mobile TV.

Because of that, mass production of mobile TV receiving chips is difficult and it is difficult to mount such a mobile TV receiving chip in a terminal at a reasonably less expensive price accordingly. Most of terminals cannot have mobile TV receiving chips mounted therein when released. as a result, to make the mobile TV market activated, there have been increasing demands for development of devices which enable users to view a mobile TV at anywhere and anytime via handheld devices with the device mounted therein and without mobile TV receiving chips mounted therein, with supporting almost all of the various typed-mobile TV signals.

### SUMMARY OF THE DISCLOSURE

Accordingly, the present invention is directed to s mobile TV service device.

An object of the present invention is to provide a mobile TV service device that can transmit a motion picture having a file format supportable by a handheld device, which is converted from a mobile TV signal received from a mobile TV network, to the handheld device or which can transmit the motion picture to the handheld device via http-streaming.

Another object of the present invention is to provide a mobile TV service device which can fixedly stand a handheld device therein by connection between a signal input/output terminal of the handheld device and a device connection terminal, such that a user may carry the mobile TV service device with the handheld device conveniently.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile TV service device includes a mobile TV signal receiver air-interfaced with a mobile TV network to receive a mobile TV signal; a device connection terminal connected with a signal input/output terminal of a handheld device; a mobile TV signal converter configured to convert the mobile TV signal into a motion picture having a format supportable by the handheld device; and a device connection controller configured to control electrical connection with the handheld device, when the handheld device is connected with the device connection terminal, and to transmit the motion picture converted from the mobile TV signal to the handheld device via the device connection terminal.

In another aspect of the present invention, a mobile TV service device includes a mobile TV signal receiving chip air-interfaced with a mobile TV network to receive a mobile TV signal; a TS formatter configured to load a TS file in a http-streaming server, the TS file segmented by a predetermined amount after packetizing audio and video signals of the mobile TV signal in a MPEG-2 TS format; a http-streaming server configured to streaming-transmit the Ts file loaded by the TS formatter to the handheld device via WiFi connection; and a WiFi chip configured to support WiFi connection with the handheld device.

According to the present invention, there are following advantageous effects.

First of all, the mobile TV service device may enable a user of a handheld device not supporting mobile TV play but supporting motion picture play to view a mobile TV program via the handheld device anywhere anytime conveniently.

Furthermore, according to the mobile TV service device, a mobile TV signal may be supplied to the handheld device by directly receiving a mobile TV signal via a mobile TV receiving chip embedded in the mobile TV service device from a corresponding network. Together with that, the mobile TV service device is designed as a stand for the handheld device and the user may carry the handheld device and the mobile TV service device more conveniently, with viewing a mobile TV service at anywhere and anytime.

A still further, according to the mobile TV service device of the present invention, a power voltage of the handheld device may be charged by using a power voltage of the mobile TV service device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 is a diagram schematically illustrating connection between a mobile TV service device and a handheld device according to an exemplary embodiment of the present invention;

FIG. 2 is a block view illustrating a configuration of the mobile TV service device according to the embodiment of the present invention; and

FIG. 3 is a block view illustrating a configuration of a mobile TV service device according to another embodiment of the present invention.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

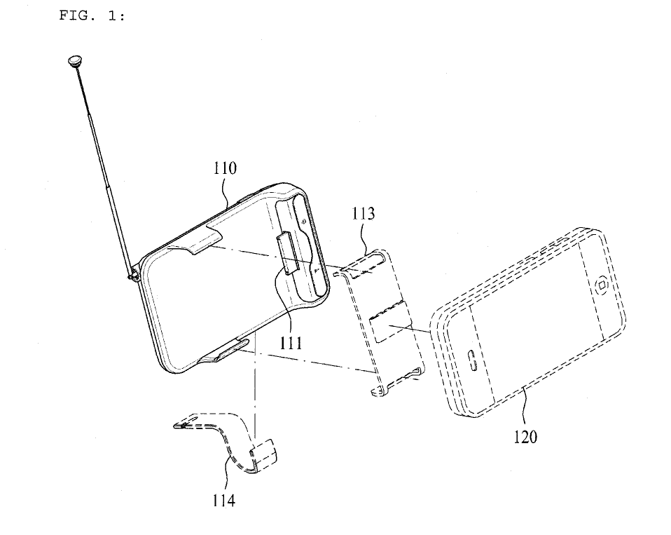

FIG. 1 is a diagram schematically illustrating connection between a mobile TV service device and a handheld device according to an exemplary embodiment of the present invention.

According to this exemplary embodiment of the present invention, a mobile TV service device 110 may be embodied as a stand-type in which a handheld device 120 is held. The handheld device 120 may be embodied to be a device capable of playing a motion picture. The handheld device 120 may be embodied into diverse types which are able to be held by cradles, for example, a mobile communication terminal, PDA, MP4 player, portable video game and the like.

The mobile TV service device 110 may be connected with the handheld device 120. The handheld device 120 may be connected with the mobile TV service device 110 via a device connection terminal 111 of the mobile TV service device 110. That is, the device connection terminal 111 may be inserted in a signal input/output terminal of the handheld device 120 such that the handheld device 120 may be held in the mobile TV service device 110.

At this time, the handheld device 120 may be connected with the TV service device 110 not only physically but also electrically via contact with the signal input/output terminal. For that, the device terminal 111 may be embodied as diverse kinds of connectors which can be electrically connected with the signal input/output terminal of the handheld device 120 (e.g. 30pin). That is, the device connection terminal 111 may have diverse kinds of connectors detachable there from according to the kinds of the signal input/output terminal.

The mobile TV service device 110 may be coupled to the handheld device 120 via a thickness adjusting member 114. After the thickness adjusting member 113 is attached to the mobile TV service device 110, the handheld device 120 is coupled to the device connection terminal 111 to be held in the mobile TV service device 110. As a result, even if the handheld device 120 is thinner than the mobile TV service device 110, the thickness adjusting member 113 makes the handheld device 120 held in the mobile TV service device 110 more securely.

The mobile TV service device 110 may stand in a stand clip 114. As the mobile TV service device 110 having the handheld device 120 attached thereto stands in the stand clip 114, a user can view a mobile TV more conveniently without holding the mobile TV service device 110 having the handheld device 120 attached thereto.

The mobile TV service device 110 may be electrically connected with the handheld device 120 via the device connection terminal 111 and a mobile TV signal may be transmitted to the handheld device 120. Alternatively, the mobile TV service device 110 may transmit the mobile TV signal to the handheld device 120 via an embedded WiFi module. In this case, the device connection terminal 111 may be only physically connected with the handheld device 120.

If it is connected with the mobile TV service device 110 via the device connection terminal, the handheld device 120 may supply a power voltage to the handheld device 120. Because of that, the handheld device 120 may be provided not only the mobile TV signal but also the power voltage by the mobile TV service device 110 to be charged with the power voltage provided by the mobile TV service device 110.

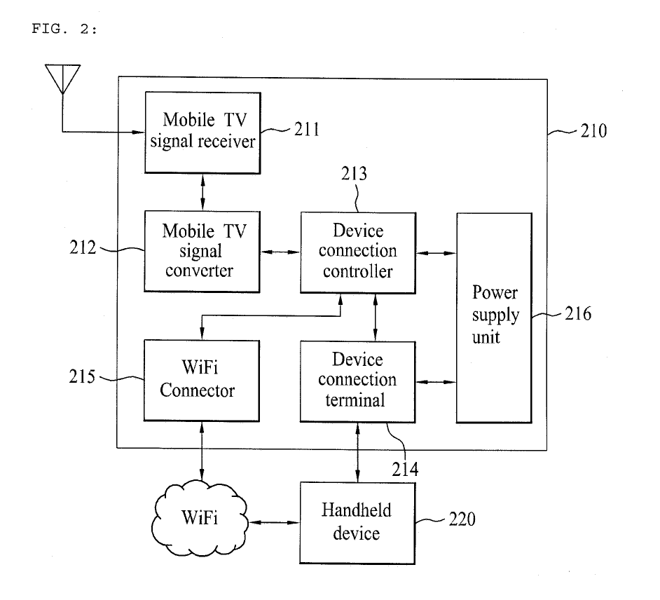

FIG. 2 is a block view illustrating the configuration of the mobile TV service device according to the exemplary embodiment of the present invention.

The mobile TV service device 210 according to this embodiment includes a mobile TV signal receiver 211, a mobile TV signal converter 212, a device connection controller 213, a device connection terminal 214, a WiFi connector 215 and a power supply unit 216.

The mobile TV signal receiver 211 is air-interfaced with a mobile TV network and it receives a mobile TV signal. The mobile TV signal may be an ATSC M/H, DMB-T, T-DMB, 1-SEG, CMMB, DVB-T, DVB-H and an existing variety of mobile TV signals.

The mobile TV signal receiver 211 implements data processing of the received mobile TV signal. For that, the mobile TV signal receiver 211 may include at least one of an ATSC M/H, DMB-T, T-DMB, 1-SEG, CMMB, DVB-T and DVB-H signal processing chip. Each of the mobile TV signal processing chips may be embodied as various kinds of signal processing chips used broadly in the art to which the present invention pertains to receive and data-process the mobile TV signal.

For example, when receiving the ATSC M/H signal via the ATSC M/H signal processing chip, the mobile TV signal receiver 211 may include an IP parser and a codec. The IP parser parses an IP packet of the ATSC M/H signal and it recognizes audio, video and data service signals from the ATSC M/H signal. The codec encodes and decodes the audio and video signals according to a preset format.

The mobile TV signal converter 212 converts the mobile TV signal received by the mobile TV signal receiver 211 into a motion picture having a format supported by the handheld device 220. for example, if the file format, video codec and audio codec of the motion picture supported by the handheld device 220 is MP4, avc1 and AAC, respectively, the mobile TV signal converter may convert the mobile TV signal into the MP4 file motion picture having audio signal and video signals encoded based on AAC audio codec and avc1 video codec, respectively. Also, the mobile TV signal converter 212 may convert the mobile TV signal into the motion picture having resolution supportable by the handheld device 220.

For that, the mobile TV signal converter 212 may keep variety of information including file format, video codec, audio codec, resolution and the like which are supportable by the handheld device 220. In case the handheld device 220 is connected with the mobile TV service device 210, the variety of the information composing the motion picture may be directly inputted by the user via a predetermined application program executed in the handheld device 220.

The device connection terminal 214 is connected with the signal input/output terminal of the handheld device. The device connection terminal 214 is inserted in the signal input/output terminal of the handheld device 220 to support the physical connection of the handheld device 220 securely held in the mobile TV service and to support electrical connection of the signal input/output the handheld device 220 with the mobile TV service device 210 via one of USB, UART and SPI connection.

The device connection controller 213 controls the electrical connection between the handheld device and the device connection terminal 214 of the mobile TV service device 210. That is, when the handheld device 220 is connected with the device connection terminal 214, the device connection controller 213 recognizes the electrical connection between the handheld device 220 and the device connection terminal 214 and it controls the operation of the mobile TV signal receiver 211 and the mobile TV signal converter 212 to transmit the mobile TV signal.

The device connection controller 213 supplies the motion picture converted from the mobile TV signal by the mobile TV signal converter 212 to the handheld device 220 via the device connection terminal 214. The device connection controller 213 may transmit a file corresponding to the motion picture to the handheld device 220 via the device connection terminal 214 directly. In this case, the handheld device 220 stores the motion picture in a memory provided therein and then it may play the motion picture via the application program.

In addition, the device connection controller 213 may allow the motion picture to be streaming-played in the handheld device 220 via the connection with the device connection terminal 214. At this time, the handheld device 220 uses a temporary file storage to play the motion picture therein via the application program, without storing the motion picture in the memory.

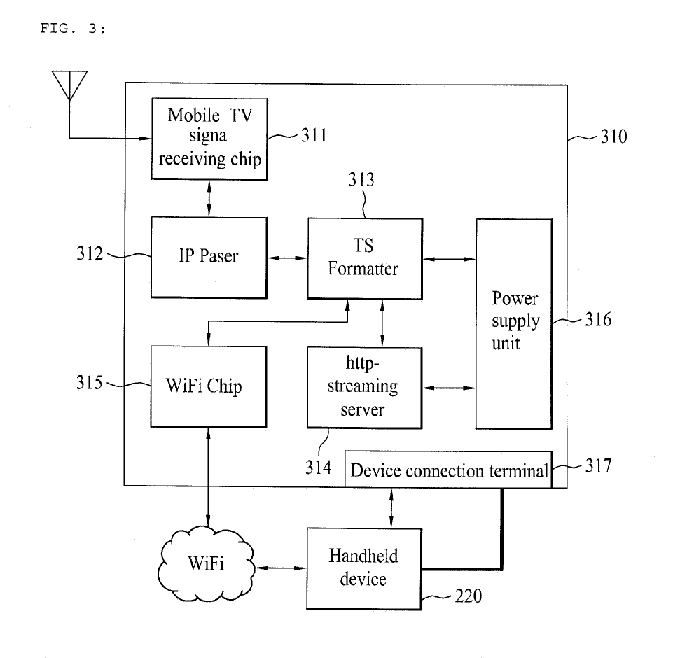

The device connection controller 213 may supply the motion picture to the handheld device 220 via the WiFi connector 215. In case the WiFi connector 215 is WiFi-connected with the handheld device 220, the device connection controller 213 may directly transmit the motion picture file to the handheld device 220 via WiFi network or it may control the motion picture to be streaming-played in the handheld device 220. The streaming-playing of the motion picture via the WiFi connection will be described later in reference to FIG. 3.

The power supply unit 216 supplies an internal power voltage of the mobile TV service device 210. If the handheld device 220 is connected with the device connection terminal 214, the power supply unit 216 may supply a power voltage to the handheld device 220. Here, the power supply unit 216 may supply the power voltage only when a remnant amount of the power supply is a predetermined value or more.

The handheld device 220 may keep a predetermined application program and the predetermined application program may be supplied by predetermined mobile TV service device selling agents. For example, the handheld device 220 is embodied as iPhone of Apple incorporated, an iPhone user may purchase the application program registered in an iTunes webstore by the mobile TV service device selling agent and he or she may install the application program in the iPhone via synchronization between the iTunes and the iPhone. The application program may be automatically executed when the handheld device 220 is connected with the mobile TV service device 210.

FIG. 3 is a block diagram illustrating a configuration of a mobile TV service device according to another embodiment of the present invention.

The mobile TV service device 310 according to this embodiment includes a mobile TV signal receiving chip 311, an IP parser 312, a TS formatter 313, a http-streaming server 314, a WiFi chip 315 and a power supply unit 316. Here, the mobile TV service device 310 according to this embodiment may further include a device connection terminal 317.

The mobile TV signal receiving chip 311 is air-interfaced with a mobile TV network and it receives a mobile TV signal. According to FIG. 3, the mobile TV signal receiving chip 311 is embodied as ATSC M/H signal receiving chip capable of receiving an ATSC M/H signal.

When the mobile TV signal receiving chip 311 receives the ATSC M/H signal, the IP parser 312 parses an IP packet of the ATSC M/H signal and it recognizes audio, video and data service signals from the ATSC M/H signal. The TS formatter 313 packetizes the audio signal and the video signal of the ATSC M/H signal based on a MPEG-2 TS format and it segments the packetized file into predetermined segments, only to load the segmented TS file in the http-streaming server 314.

The http-streaming server 314 transmits the TS file loaded by the TS formatter 313 to the handheld device 320 via WiFi connection of the WiFi chip 315 configured to support the WiFi connection with the handheld device 320.

The operations of such the mobile TV signal receiving chip 311, IP parser 312, TS formatter 313, http-streaming server 314 and WiFi chip 315 may enable the mobile TV service device 310 to implement the streaming-service of the mobile TV signal to the handheld device 320 via the WiFi.

The device connection terminal 317 is inserted in a signal input/output terminal of the handheld device 320 to support physical connection between the handheld device 320 and the mobile TV service device 310, such that the handheld device 320 may be fixedly held in the mobile TV service device 310, and to support electrical connection between the signal input/output terminal of the handheld device 320 and the mobile TV service device 310 via one of USB, TART and SPI connection. The device connection terminal 317 may be embodied as power supply terminal configured to enable the power supply unit 316 to supply a power voltage to the handheld device 320 via a predetermined connector.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile TV service device comprising:
a mobile TV signal receiver air-interfaced with a mobile TV network to receive a mobile TV signal;
a device connection terminal connected with a signal input/output terminal of a handheld device;
a mobile TV signal converter configured to convert the mobile TV signal into a motion picture having a format supportable by the handheld device; and
a device connection controller configured to control electrical connection with the handheld device, when the handheld device is connected with the device connection terminal, and to transmit the motion picture converted from the mobile TV signal to the handheld device via the device connection terminal.

2. The mobile TV service device of claim 1, wherein the mobile TV signal is one of ATSC M/H signal, DMB-T signal, T-DMB signal, 1-SEG signal, CMMB signal, DVB-T signal and DBV-H signal, and the mobile TV signal receiver comprises one or more of ATSC M/H signal processing chip, DMB-T signal processing chip, T-DMB signal processing chip, 1-SEG signal processing chip, CMMB signal processing chip, DVB-T signal processing chip and DBV-H signal processing chip.

3. The mobile TV service device of claim 1, wherein the device connection terminal is inserted in the signal input/output terminal of the handheld device to support physical connection for the handheld device to be fixedly connected with the mobile TV service device, and to support electrical connection of the signal input/output terminal of the handheld device via one of USB, UART and SPI connection.

4. The mobile TV service device of claim 1, wherein the handheld device maintains a predetermined application program configured to play based on the motion picture converted from the mobile TV signal which is received from the mobile TV service device and the predetermined application program is automatically executed when the signal input/output terminal of the handheld device is electrically connected with the device connection terminal.

5. The mobile TV service device of claim 1, wherein the device connection controller transmits the motion picture file to the handheld device.

6. The mobile TV service device of claim 1, wherein the device connection controller controls the motion picture to streaming-played in the handheld device via the application program maintained by the handheld device.

7. The mobile TV service device of claim 1, further comprising:
a WiFi connecting unit configured to support WiFi connection with the handheld device,
wherein the device connection controller transmits the motion picture to the handheld device via the WiFi connection or the device connection controller controls the motion picture to be streaming-played in the handheld device via the WiFi connection.

8. The mobile TV service device of claim 1, further comprising:
a power supply unit configured to supply an internal power voltage of the mobile TV service device and to supply a power voltage to the handheld device when the handheld device is connected with the device connection terminal.

9. The mobile TV service device of claim 8, wherein the power supply unit supplies the power voltage to the handheld device only when the mobile TV service device receives an AC power voltage or a remnant amount of the power voltage is a predetermined amount or more.

10. A mobile TV service device comprising:
a mobile TV signal receiving chip air-interfaced with a mobile TV network to receive a mobile TV signal;
a TS formatter configured to load a TS file in a http-streaming server, the TS file segmented by a predetermined amount after packetizing audio and video signals of the mobile TV signal in a MPEG-2 TS format;
a http-streaming server configured to streaming-transmit the Ts file loaded by the TS formatter to the handheld device via WiFi connection; and
a WiFi chip configured to support WiFi connection with the handheld device.

11. The mobile TV service device of claim 10, further comprising:
an IP parser configured to parse an IP packet of an ATSC M/H signal to recognize audio, video and data service signals from the ATSC M/H signal, when the mobile TV receiving chip receives the ATSC M/H signal.

12. The mobile TV service device of claim 10, further comprising:
a device connection terminal inserted in an input/output terminal of the handheld device to support physical connection for the handheld device to be to support physical connection for the handheld device to be fixedly connected with the mobile TV service device, and to support electrical connection of the signal input/output terminal of the handheld device via one of USB, UART and SPI connection; and
a file transmitting unit configured to transmit a Ts file to the handheld device via the device connection terminal, when the signal input/output terminal of the handheld device is electrically connected with the device connection terminal.

13. The mobile TV service device of claim 10, further comprising:
a power supply unit configured to supply an internal power voltage of the mobile TV service device and to supply a power voltage to the handheld device via the connection with the handheld device.

14. The mobile TV service device of claim 13, wherein the power supply unit supplies the power voltage to the handheld device only when the mobile TV service device receives an AC power voltage or a remnant amount of the power voltage is a predetermined amount or more.

15. The mobile TV service device of claim 10, wherein the handheld device maintains an application program configured to streaming-play the TS file received from the http-streaming server via the WiFi.
